(19) United States
(12) Patent Application Publication
(10) Pub. No.: US 2005/0211531 A1
(43) Pub. Date: Sep. 29, 2005

(54) Apparatus of conveying LCD's substrate

(75) Inventors: Sang-gab Kim, Seoul (KR); Hee-hwan Choe, Incheon City (KR); Sung-chul Kang, Yongin-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 10/962,709

(22) Filed: Oct. 13, 2004

(30) Foreign Application Priority Data
Oct. 14, 2003 (KR) 2003-0071492

(51) Int. Cl. B65G 35/00

(52) U.S. Cl. 198/618

(57) ABSTRACT

An apparatus of conveying a substrate for an LCD having a size of 1500 mm×1800 mm or more, comprises a pair of parallel supporting arms being shaped like a bar and supporting opposite edge areas of the substrate; and at least one auxiliary arm disposed between the supporting arms. With this configuration, the present invention provides a conveying apparatus which minimizes deformation of a large-sized substrate for an LCD while conveying the substrate, thereby preventing a defective due to the deformation and stabilizing a manufacturing process.

### CROSS-REFERENCE TO RELATED APPLICATIONS

This application claims the benefit of Korean Patent Application No. 2003-0071492, filed Oct. 14, 2003, in the Korean Intellectual Property Office, the disclosure of which is incorporated herein by reference.

### BACKGROUND OF THE INVENTION

1. Field of the Invention

The present invention relates to an apparatus for conveying a substrate, and more particularly, to an apparatus of conveying a substrate for a liquid crystal display (LCD), minimizing deformation of the substrate.

2. Description of the Related Art

In an LCD, a liquid crystal is sandwiched between a substrate with a thin film transistor (TFT) and a substrate with a color filter. Here, the substrate used in the LCD is made of glass, quartz, etc. The glass most widely used for the substrate has similar composition to Alumino-Silicate. The substrate has to satisfy various conditions such as low density, high heat-resisting property, chemical-resisting property, excellent mechanical property, etc. To satisfy these conditions, the glass contains a high percentage of a mesh-forming element such as Silica, Alumina, etc., thereby shortening life span of a melting furnace and requiring high technology.

There are various methods of manufacturing the glass substrate. For example, the glass substrate can be manufactured by a float method, a down draw method, a fusion method, etc. Among these methods, the float method is most widely used and has advantages of being easy to manufacture a large-sized substrate and having a high mass-productivity.

Most of the current glass substrate has a thickness of 1.1 mm, 0.7 mm, etc. Recently, the glass substrate having a thickness of 0.5 mm, 0.4 mm, etc. is being used in telecommunication appliances. Because the thickness of the substrate directly affects the weight and the thickness of the LCD, the substrate has a tendency to become thinner.

The substrate can have various sizes according to a production line. To reduce cost or to manufacture a large-sized LCD such as a large-sized television, the substrate has a tendency to become larger. Recently, a short edge of the substrate has a length of 1500 mm or more.

In a process of manufacturing the LCD, a conveyer or a roller is employed as a method of conveying the substrate. In this case, the conveyer or the roller evenly supports the substrate, so that the substrate is not deformed by being conveyed. However, a dry etching process is performed in vacuum, so that it is impossible to employ the conveyer or the roller for conveying the substrate in the dry etching process. Therefore, in the dry etching process, an apparatus having a supporting arm is used in conveying the substrate. In the conventional conveying apparatus, the substrate is supported by two supporting arms. The supporting arm is generally made of a metal material and shaped like a bar. On an upper surface of the supporting arm is provided a rubber ring, and the substrate is supported by contacting the rubber ring, thereby preventing a defective due to direct contact with the metallic supporting arm.

FIG. 1 is a perspective view illustrating a conventional conveying apparatus supporting a substrate, wherein the conveying apparatus comprises a supporting arm, and a structure related to the supporting arm is concentratedly illustrated. In FIG. 1, two supporting arms 200 having a bar shape are disposed along a lengthwise direction of the substrate 100, supporting the substrate 100. FIG. 2 is a sectional view of FIG. 1, taken along line II-II. FIG. 2 illustrates deformation of the substrate 100 in the conventional supporting structure of the supporting arm. The deformation can be represented as a vertical distance (refer to ‘s’ in FIG. 2) between a horizontal plane (before deformed) and a maximum deformed part of the substrate 100.

In the conventional conveying apparatus, even if the supporting arms are rearranged to minimize the deformation of the substrate 100, the current glass substrate has a deformation of 20 mm or more. Here, the most deformed part of the substrate 100 is ‘a’, ‘b’ and ‘c’ as shown in FIG. 2. Further, the larger the size of the substrate 100 is, the more the substrate is deformed.

When the substrate is deformed, patterns formed on the substrate may be defective. The larger the size of the substrate is, the more such problem arises and the greater the damage is. Further, as the LCD tends to become lighter and slimmer, the substrate will become thinner. The thinner substrate is, the more the substrate is likely to be deformed. In the case of the conventional substrate having a size of 1500 mm×1800 mm or less, such deformation can be ignored. However, in the case of a prospective substrate having a size of 1500 mm×1800 mm or more, such deformation cannot be ignored. Also, the foregoing problems arise even though the substrate is made of the quartz or other materials as well as the glass. Further, the conventional supporting arm structure is not enough to solve the foregoing problems.

### SUMMARY OF THE INVENTION

Accordingly, it is an aspect of the present invention to provide an apparatus of conveying a substrate for an LCD, using a supporting arm, which minimizes deformation of the substrate while conveying the substrate.

Additional aspects and/or advantages of the invention will be set forth in part in the description which follows and, in part, will be obvious from the description, or may be learned by practice of the invention.

The foregoing and/or other aspects of the present invention are achieved by providing an apparatus of conveying a substrate for an LCD having a size of 1500 mm×1800 mm or more, comprising a pair of parallel supporting arms being shaped like a bar and supporting opposite edge areas of the substrate; and at least one auxiliary arm disposed between the supporting arms.

According to an aspect of the invention, each supporting arm is spaced from an edge of the substrate by 10% through 16% of a distance between the opposite edges of the substrate.

According to an aspect of the invention, the auxiliary arm is shaped like a bar, being parallel with the supporting arm.

According to an aspect of the invention, the supporting arm is disposed along a lengthwise direction of the substrate.

According to an aspect of the invention, the supporting arm is disposed along a widthwise direction of the substrate.

### BRIEF DESCRIPTION OF THE DRAWINGS

These and other aspects and advantages of the present invention will become apparent and more readily appreciated from the following description of the embodiments, taken in conjunction with the attached drawings of which:

FIG. 1 is a perspective view illustrating a conventional conveying apparatus supporting a substrate;

FIG. 2 is a sectional view of FIG. 1, taken along line II-II;

FIGS. 3A through 3E are top plan views of a conveying apparatus supporting the substrate, according to various embodiments of the present invention; and

FIGS. 4A through 4C are top plan views of the conveying apparatus supporting the substrate, employed in first through third simulations.

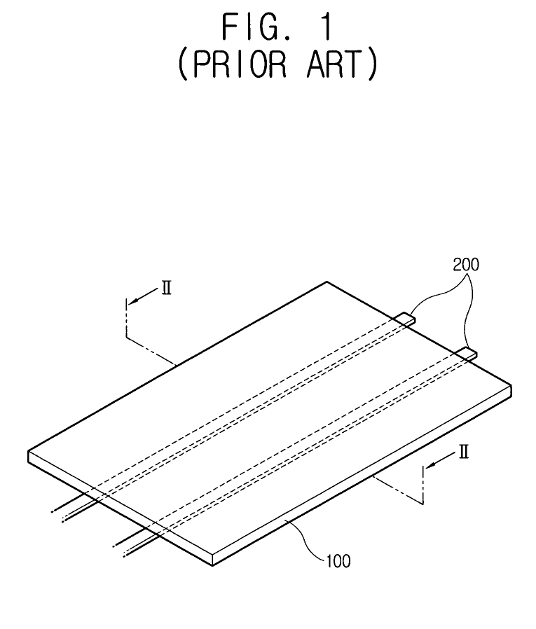

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

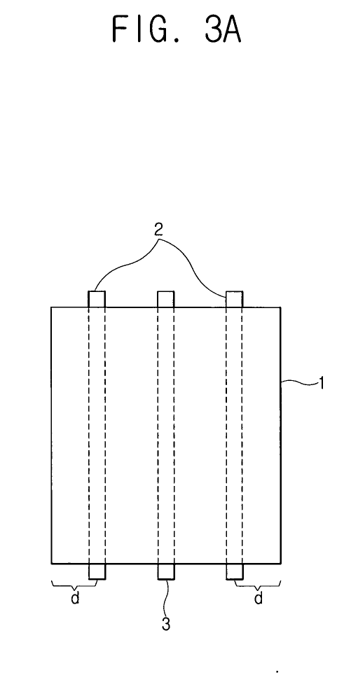

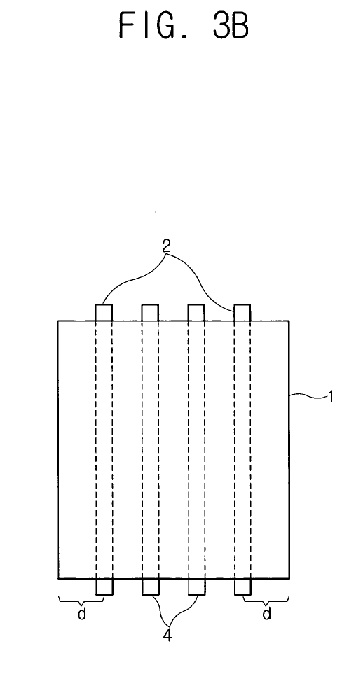

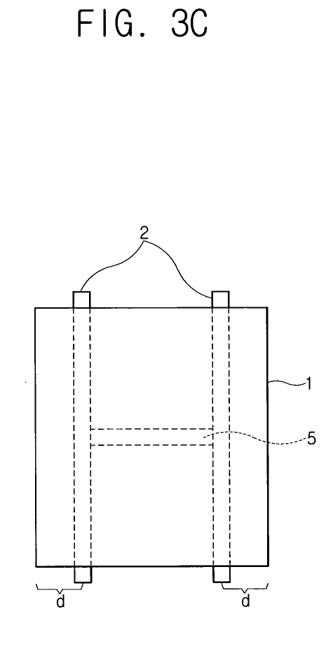

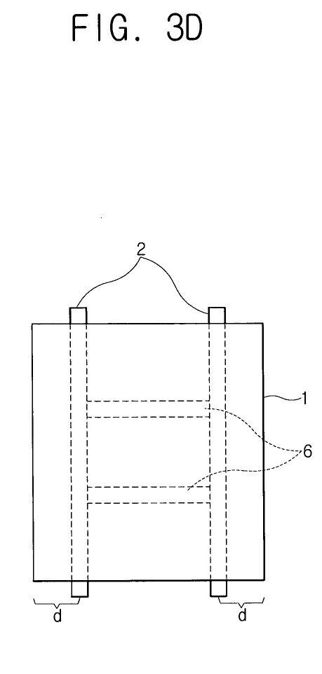

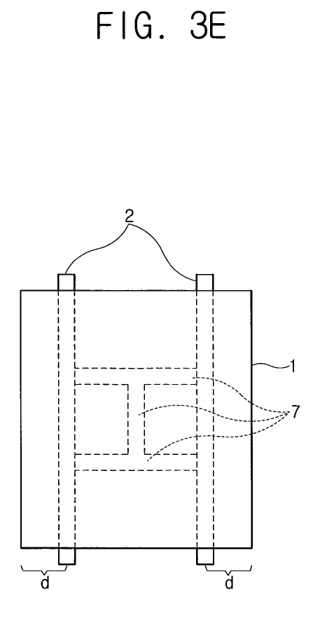

FIGS. 3A through 3E are top plan views of a conveying apparatus supporting the substrate according to first through fifth embodiments of the present invention, wherein various structures of an auxiliary arm are illustrated.

A substrate is generally shaped like a rectangular plate, and four edges of the substrate includes a pair of lengthwise edges and a pair of widthwise edges. In these embodiments, supporting arms are parallel with the lengthwise edges.

In the first embodiment (refer to FIG. 3A), one auxiliary arm 3 having a bar shape like a supporting arm 2 is provided. In the second embodiment (refer to FIG. 3B), two auxiliary arms 4 having a bar shape like the supporting arm 2 are provided. Preferably, the auxiliary arms 3 and 4 are parallel with the supporting arms 2, and each of the auxiliary arms 3 and 4 is spaced from the supporting arms 2 at regular intervals.

In the third embodiment (refer to FIG. 3C), one auxiliary arm 5 is provided connecting the supporting arms 2. In the fourth embodiment (refer to FIG. 3D), two auxiliary arms 6 are provided connecting the supporting arms 2.

In the fifth embodiment (refer to FIG. 3E), an auxiliary arm 7 is provided as combination of the foregoing structures.

Besides the foregoing embodiments, the number and the shape of the auxiliary arm can vary according to the size of the substrate or handling convenience.

Here, a distance ‘d’ from the lengthwise edge to the supporting arm has to be within 10% through 16% of the length of the widthwise edge. If the distance ‘d’ is less than 10%, the auxiliary arm is excessively used to prevent the middle of the substrate from being deformed. Oppositely, if the distance ‘d’ is more than 16%, it is difficult to prevent both the lengthwise edges from being deformed.

In the first and second embodiments, the supporting arm is parallel with the lengthwise edges of the substrate, which has an advantage over being parallel with the widthwise edges in terms of preventing the substrate from being deformed. However, the supporting arm can be parallel with the widthwise of the substrate in consideration of the size and conveying conditions of the conveying apparatus. Further, it should be appreciated that the present invention is applicable to the supporting arm being parallel with the widthwise edges of the substrate.

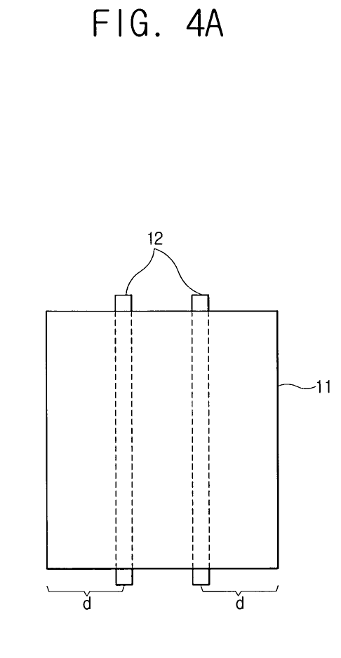

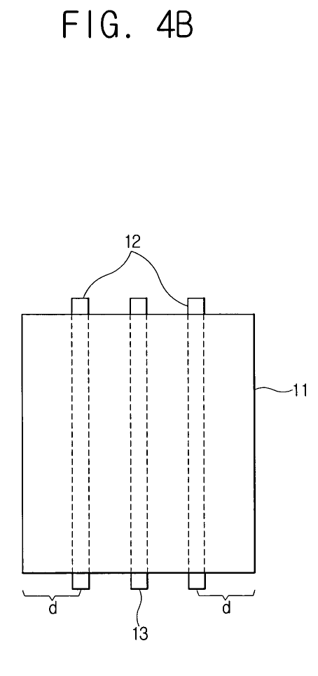

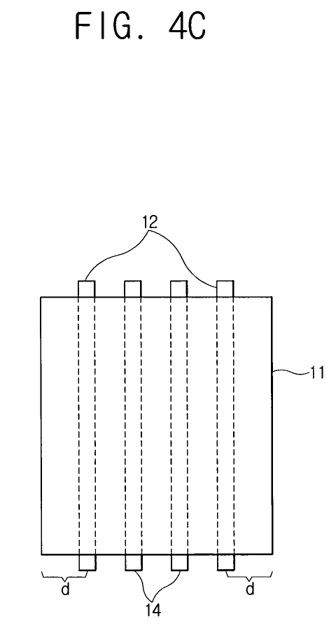

Hereinbelow, the present invention will be in more detail described with reference to simulation results. FIGS. 4A through 4C are top plan views of the conveying apparatus supporting the substrate, employed in first through third simulations. In the first through third simulations, the supporting arms are parallel with the lengthwise edges of the substrate.

The first simulation (refer to FIG. 4A) is performed in the conventional supporting structure of the supporting arms without the auxiliary arm, wherein the distance ‘d’ from the lengthwise edges of the substrate to the supporting arm 12 is variable.

The second simulation (refer to FIG. 4B) is performed in a state that one bar-shaped auxiliary arm 13 is parallel with the supporting arms 12 and spaced from the supporting arms 12 at regular intervals, wherein the auxiliary arm 13 is invariably positioned in the middle of the substrate 11 and the distance ‘d’ is variable.

The third simulation (refer to FIG. 4C) is performed in a state that two bar-shaped auxiliary arms 14 are parallel with the supporting arms 12 and spaced from the supporting arms 12 at regular intervals, wherein the distance ‘d’ is ⅛ of the length of the widthwise edge of the substrate.

The foregoing simulations are performed using a glass substrate, wherein a 1737 glass substrate and an EAGLE 2000 glass substrate of SAMSUNG Corning Co., Ltd. are used as a sample. Each sample glass substrate has two kinds of thickness (0.63 mm and 0.7 mm) and two kinds of size (1500 mm×1800 mm and 1800 mm×2000 mm), that is, the total number of sample glass substrates used in the foregoing simulations is eight. Property of each sample glass used in the foregoing simulations is shown in <Table 1>, as follows.

TABLE 1

Substrate

| | 1737 | EAGLE 2000 |
|---|---|---|
| Young's Modulus(GPa) | 69.361 | 69.233 |
| Poison's Ratio | 0.24 | 0.23 |
| Density(g/cm3) | 2.54 | 2.37 |

Hereinbelow, the results of the simulations for the structures of FIGS. 4A through 4C will be described.

[No Auxiliary Arm]

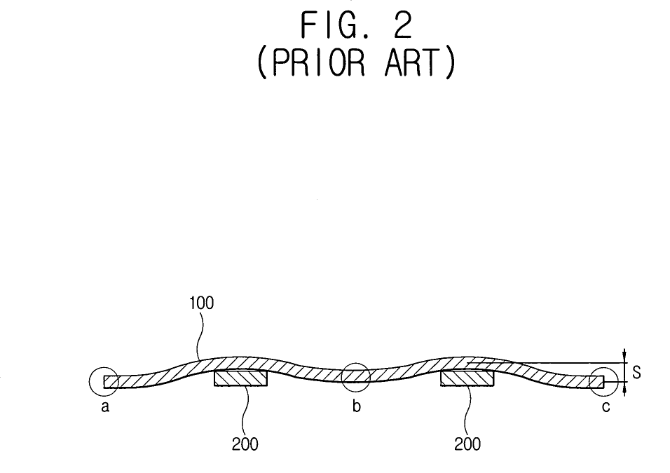

As shown in FIG. 4A, the first simulation for the conventional supporting structure is performed without the auxiliary arm. Table 2 shows the maximum deformation (mm) corresponding to the distance ‘d’ from the lengthwise edge to the supporting arm 12 in the case of the substrate 11 having a size of 1500 mm×1800 mm. Similarly, Table 3 relates to the substrate 11 having a size of 1800 mm×2000 mm. Here, the deformation (mm) means ‘s’ in FIG. 2.

TABLE 2
(unit: mm)

| | 1737 | 1737 | EAGLE 2000 | EAGLE 2000 |
|---|---|---|---|---|
| d(mm) | (0.63 mm) | (0.7 mm) | (0.63 mm) | (0.7 mm) |
| 50 | 381.77 | 341.15 | 369.97 | 328.81 |
| 100 | 345.95 | 302.87 | 333.22 | 290.19 |
| 150 | 295.94 | 253.12 | 283.02 | 240.97 |
| 200 | 229.69 | 191.99 | 218.05 | 181.71 |
| 250 | 148.95 | 122.35 | 140.59 | 115.31 |
| 300 | 60.73 | 49.51 | 57.17 | 46.57 |
| 350 | 31.25 | 25.43 | 29.40 | 23.91 |
| 400 | 102.71 | 84.43 | 96.97 | 79.59 |
| 450 | 167.61 | 139.09 | 158.74 | 131.41 |
| 500 | 220.47 | 184.67 | 209.44 | 174.87 |

TABLE 3
(unit: mm)

| | 1737 | 1737 | EAGLE 2000 | EAGLE 2000 |
|---|---|---|---|---|
| d(mm) | (0.63 mm) | (0.7 mm) | (0.63 mm) | (0.7 mm) |
| 50 | 568.40 | 531.73 | 558.08 | 519.9 |
| 100 | 548.27 | 506.43 | 536.41 | 493.11 |
| 150 | 516.89 | 469.28 | 503.25 | 454.45 |
| 200 | 468.20 | 415.47 | 452.82 | 399.59 |
| 250 | 394.03 | 340.08 | 377.90 | 324.54 |
| 300 | 287.34 | 241.21 | 273.17 | 228.54 |
| 350 | 151.18 | 124.68 | 142.89 | 117.62 |
| 400 | 31.01 | 25.21 | 29.16 | 23.7 |
| 450 | 128.84 | 107.25 | 122.15 | 101.4 |
| 500 | 238.60 | 201.85 | 227.39 | 191.61 |

As a result of the first simulation shown in Tables 2 and 3, the distances ‘d’ having the minimum deformation in Tables 2 and 3 are 335 mm and 400 mm, respectively. Such distances are 22.3% and 22.2% of the widthwise edge lengths of 1500 mm and 1800 mm of the substrates 11, respectively. Therefore, even though the supporting arms 12 are arranged in optimum positions, the substrate 11 is deformed having the deformation ‘s’ of about 20 mm or more. The more the supporting arms 12 are close to the lengthwise edges of the substrate 11, the more the deformation arises in the middle of the substrate 11. Oppositely, the more the supporting arms 12 are distant from the lengthwise edges of the substrate 11 (close to the middle of the substrate 11), the more the deformation arises in the lengthwise edges of the substrate 11.

[One Auxiliary Arm]

As shown in FIG. 4B, the second simulation is performed with one auxiliary arm 13. The one auxiliary arm 13 is positioned in the middle of the substrate 11. Table 4 relates to the substrate 11 having a size of 1500 mm×1800 mm, and Table 5 relates the substrate 11 having a size of 1800 mm×2000 mm.

TABLE 4
(unit: mm)

| | 1737 | 1737 | EAGLE 2000 | EAGLE 2000 |
|---|---|---|---|---|
| d(mm) | (0.63 mm) | (0.7 mm) | (0.63 mm) | (0.7 mm) |
| 50 | 16.68 | 13.54 | 15.68 | 12.73 |
| 100 | 14.11 | 11.46 | 13.26 | 10.77 |
| 150 | 9.49 | 7.72 | 8.92 | 7.25 |
| 200 | 3.20 | 2.62 | 3.01 | 2.46 |
| 250 | 8.69 | 7.05 | 8.17 | 6.62 |
| 300 | 21.53 | 17.47 | 20.24 | 16.42 |
| 350 | 38.60 | 31.37 | 36.3 | 29.49 |

TABLE 5
(unit: mm)

| | 1737 | 1737 | EAGLE 2000 | EAGLE 2000 |
|---|---|---|---|---|
| d(mm) | (0.63 mm) | (0.7 mm) | (0.63 mm) | (0.7 mm) |
| 50 | 34.91 | 28.35 | 32.82 | 26.65 |
| 100 | 30.3 | 25.41 | 29.42 | 23.88 |
| 150 | 24.93 | 20.23 | 23.42 | 19.01 |
| 200 | 15.33 | 12.45 | 14.41 | 11.7 |
| 250 | 5.46 | 4.45 | 5.13 | 4.18 |
| 300 | 17.95 | 14.57 | 16.88 | 13.69 |
| 350 | 39.29 | 31.96 | 36.95 | 30.05 |

As a result of the second simulation shown in Tables 4 and 5, the distances ‘d’ having the minimum deformation in Tables 4 and 5 are 213 mm and 256 mm, respectively. Such distances are 14.2% of both the widthwise edge lengths of 1500 mm and 1800 mm of the substrates 11, respectively. Therefore, when the supporting arms 12 are arranged in optimum positions, the deformation ‘s’ of the substrate 11 is less than 6 mm. Because the auxiliary arm 13 is added, even though the supporting arms 12 are positioned more closely to the lengthwise edges of the substrate 11, the deformation in the middle of the substrate 11 is not large.

Two Auxiliary Arms]

As shown in FIG. 4C, the third simulation is performed with two auxiliary arms 14. Here, the position of the supporting arms 12 and the two auxiliary arms 14 is invariable. Further, the distances ‘d’ are 12.5% of the widthwise edge lengths of 1500 mm and 1800 mm of the substrates 11, respectively. Table 6 shows the maximum deformations of the substrates 11 having sizes of 1500 mm×1800 mm and 1800 mm×2000 mm.

TABLE 6
(unit: mm)

| Substrate | 1500 mm × 1800 mm | 1800 mm × 2000 mm |
|---|---|---|
| 1737(0.63 mm) | 3.03 | 6.26 |
| 1737(0.7 mm) | 2.45 | 5.07 |
| EAGLE 2000(0.63 mm) | 2.84 | 5.88 |
| EAGLE 2000(0.7 mm) | 2.30 | 4.77 |

As a result of the foregoing simulations, in the conventional supporting structure, the distance ‘d’ corresponding to the minimum deformation is about 22% of the widthwise edge length. However, in the case where one auxiliary arm is added, the distance ‘d’ corresponding to the minimum deformation is about 14% of the widthwise edge length. Further, in the case where when two auxiliary arms are added, the distance ‘d’ corresponding to the minimum deformation is less than 14% of the widthwise edge length.

Consequently, when a large-sized substrate is conveyed, the large-sized substrate has a deformation of 20 mm or more in the conventional conveying apparatus, but has a deformation of 10 mm or less in the conveying apparatus according to the present invention. Although the large-sized substrate is conveyed by the conveying apparatus according to the present invention, if one auxiliary arm is added and the distance ‘d’ is increased beyond 16% of the widthwise edge length, the deformation is not significantly improved than that of the conventional conveying apparatus.

The simulation results may vary according to the size and the thickness of the substrate. Further, it should be appreciated that the present invention is applicable to various substrates by properly changing a supporting structure.

The foregoing simulations are performed using the glass substrate, but can be preformed using the substrate made of other materials. Either way, the result is the same. Further, in the above-described embodiments, the supporting arm is parallel with the lengthwise edge of the substrate, but may be parallel with the widthwise edge of the substrate. Either way, the result is the same.

As described above, the present invention provides a conveying apparatus which minimizes deformation of a large-sized substrate for an LCD while conveying the substrate, thereby preventing a defective due to the deformation and stabilizing a manufacturing process.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An apparatus of conveying a substrate for an LCD having a size of 1500 mm×1800 mm or more, comprising:
a pair of parallel supporting arms being shaped like a bar and supporting opposite edge areas of the substrate; and
at least one auxiliary arm disposed between the supporting arms.

2. The apparatus according to claim 1, wherein each supporting arm is spaced from an edge of the substrate by 10% through 16% of a distance between the opposite edges of the substrate.

3. The apparatus according to claim 1, wherein the auxiliary arm is shaped like a bar, being parallel with the supporting arm.

4. The apparatus according to claim 1, wherein the supporting arm is disposed along a lengthwise direction of the substrate.

5. The apparatus according to claim 1, wherein the supporting arm is disposed along a widthwise direction of the substrate.
